(19) United States
(12) Patent Application Publication
(10) Pub. No.: US 2013/0212600 A1
(43) Pub. Date: Aug. 15, 2013

(54) CONSTRAINED MODE FOR RUNNING APPLICATIONS

(71) Applicant: Microsoft Corporation, (US)

(72) Inventors: Michael Ryan Harsh, Redmond, WA (US); Brian Kingsley Hudson, Kirkland, WA (US); Reza Nourai, Kirkland, WA (US); William Lord Hayward, Kirkland, WA (US)

(73) Assignee: Microsoft Corporation, Redmond, WA (US)

(21) Appl. No.: 13/768,867

(22) Filed: Feb. 15, 2013

Related U.S. Application Data
(60) Provisional application No. 61/599,373, filed on Feb. 15, 2012.

(51) Int. Cl. G06F 9/50

(52) U.S. Cl. CPC G06F 9/50
USPC 719/318

(57) ABSTRACT

The subject disclosure is directed towards a technology in which a game console or mobile device is able to run applications in parallel in different running modes/states. In a constrained running mode, an application has reduced resources available to the application relative to resources available to an application that is run in full running mode. Also described is transitioning between the running modes/states, as well as to and from other states.

### CROSS-REFERENCE TO RELATED APPLICATION

The present application claims priority to U.S. provisional patent application serial no. 61/599373, filed Feb. 15, 2012

### BACKGROUND

On early contemporary computing devices that had relatively low computational power (e.g., compared to a PC), such as a mobile device or game console, if an application was running and was subsequently replaced in the foreground by another application (or title), the first application was deactivated and the application's process terminated by the operating system.

As this was rather inconvenient at times to the user, one improvement was to save state of the application before deactivation, and then restore that state if and when that application was reactivated. However, when returning to an application that was terminated by the operating system, the user needed to wait for the device application framework to initialize, and for the application itself to load saved state to resume the previous experience. Resuming in this way was relatively slow and thus provided a somewhat undesirable user experience.

In more recent devices, another improvement is the concept of a dormant state, in which the shell component/framework that comprises the (e.g., Windows® phone) application platform retains the application process in memory, and maintains state and execution context for the application. This eliminates the need to reinitialize the application and reload state, and thus allows for much faster reactivation. However, a dormant application is limited in that it may not execute code when in the background, and instead regains the ability to execute code when the user brings the application out of the dormant state. As such computing devices grow in power, users expect more and more features with respect to application execution.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an application is moved from a full running (e.g., primary user experience) state into a constrained running mode (or state) in which the application process is able to execute code with reduced resources.

In one aspect, a shell component is configured to run applications in different modes, including to run an application in a constrained running mode, in which the constrained running mode has reduced resources available to the application relative to resources available to applications in a full running mode, the application in the constrained running mode configured to run in parallel with another application that is run in a full running mode.

In one aspect, there is described moving a running application from a full running state into a constrained running state, including notifying the application of a state transition. Also described is reducing one or more resources available to the constrained application including reducing a number of CPU (central processing unit) cores reserved to the application, an amount of memory accessible to the application, GPU (graphics processing unit) access of the application, and/or screen area accessible to the application.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example applications in different modes/states as controlled by an operating system shell, including an application in a full mode and one or more applications in a constrained mode, according to one example embodiment.

FIG. 2 is state diagram showing example states for applications, including a full running state and a constrained running state, and transitions between the states, according to one example embodiment.

FIG. 3 is a flow diagram showing example steps that may be taken with respect to transitioning between various modes, including a full running mode and a constrained running mode according to one example embodiment.

FIG. 4 is a block diagram representing an exemplary non-limiting computing system or operating environment, e.g., in the example of a gaming console, in which one or more aspects of various embodiments described herein may be implemented.

### DETAILED DESCRIPTION

Various aspects of the technology described herein are generally directed towards a technology in which an application that is not the primary user experience is able to continue running in a constrained mode (state), in which the application can do some work in parallel but is only allocated limited resources. Note that as used herein, “mode” and “state” are generally synonymous with respect to management of applications. While running an application in the constrained mode, another application (or another application instance) may run in a full state.

It should be understood that any of the examples herein are non-limiting. For one, example implementations and constrained applications are described in the context of a game console operating environment, however this is only for purposes of explanation, and other operating environments such as mobile device environments may benefit from the concept of a constrained application state as described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and application/process management in general.

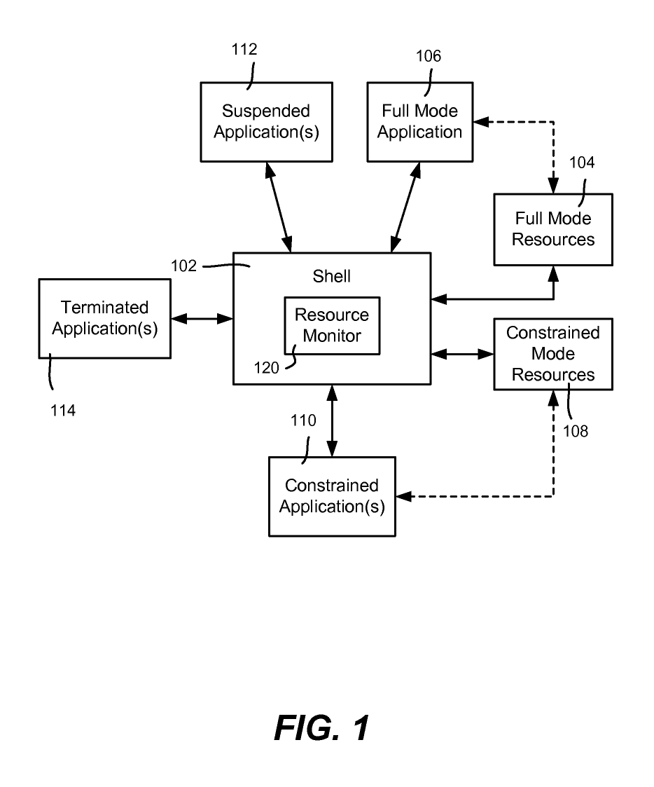

FIG. 1 is a generalized block diagram showing various example components in a computing device environment. A plurality of applications are controlled by a shell 102 (application framework), which provides applications with access to device resources (e.g., display, CPU, GPU, memory, networking and so forth). As described herein, this includes full mode resources 104 that a full mode application 106, e.g., one loaded and initialized as the primary user experience application running in a full state, typically can access.

As described herein, the shell 102 also provides a reduced amount of “constrained mode” resources 108 for access by a constrained application 110.

As will be understood, this allows the constrained application 110 to run in parallel with the full mode application 106 so as to perform some work. Note that it is feasible to have more than one constrained mode application, each performing some parallel work using reduced resources. For purposes of simplicity, the description hereinafter generally will be directed towards one constrained mode application.

As also exemplified in FIG. 1, one or more applications may be suspended mode application(s) 112, while one or more other applications may be terminated application(s) 114. As suspended and terminated applications are known states, they are only generally described hereinafter. Other states such as tombstoned (the application is given a chance to save state, after which the process is torn down and a marker of its prior existence is kept on an application stack) are not shown, but may be present in a given implementation.

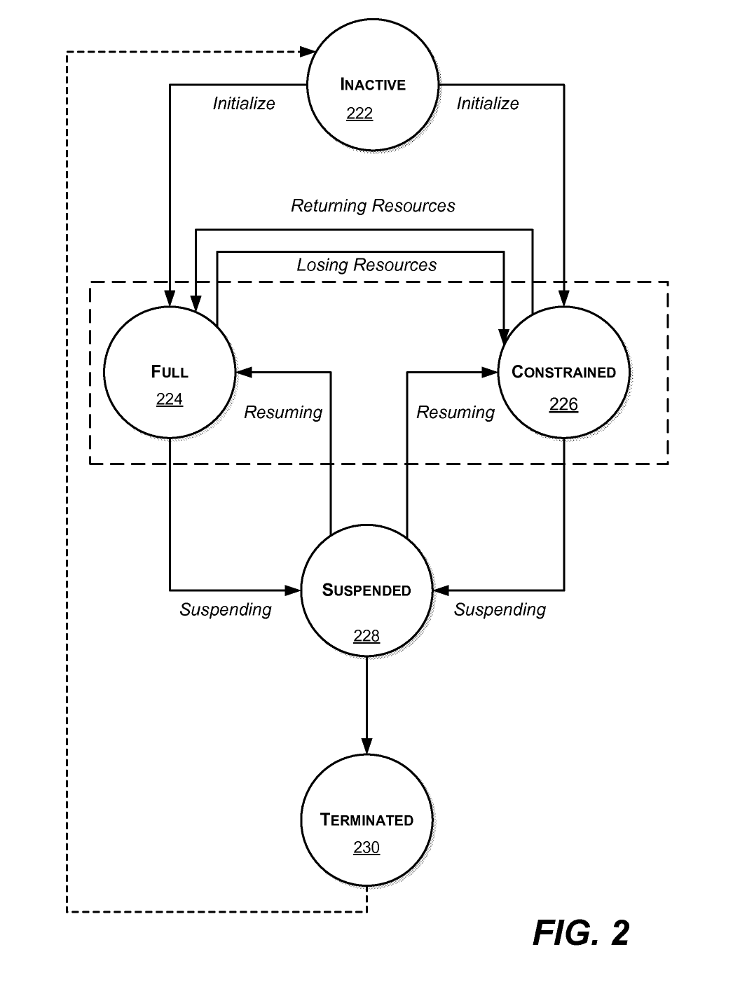

FIG. 2 is a state diagram showing example process lifetime states of an application once the user or operating system launches the application from an inactive state (block 222) and the application is initialized; initializing may be a process lifetime management event. In one implementation, applications are subject to dynamic resource allocation limits that can change at any time. The full running state 224 and constrained running state 226 correspond to two resource allocation states, namely full and constrained.

As can be seen in FIG. 2, when initialized, the application may transition to one of two running states, namely a full state 224 or a constrained state 226. For example, a user will launch an application into the full state 224, whereas the operating system may launch a previously suspended and terminated application into the running state it was previously in before being suspended, that is, either the full state 224 or the constrained state 226 in this example. Note that the application knows whether it is being started by the user for the first time, or whether the application was terminated from the suspended state and thereafter restarted by the user, as described below. In some embodiments, it is also feasible for another program such as an operating system component (e.g., a scheduler) or another application may to launch an application for the first time into the constrained mode to do some background work.

In one implementation in which each application has an associated object, the full and constrained states are facilitated by one or more properties/data in the object, and an event that is fired when a running application transitions between the full and constrained states. To disambiguate which state an application is in when it is activated or resuming, the application examines its associated application object.

To operate properly, an application that transitions from the full state 224 to the constrained state 226 needs to reduce its resource usage when possible (e.g., pause the game, switch to a minimal “glanceable” data view, and so forth). The platform guarantees correctness of execution when resources are reduced. Note however that some dedicated hardware APIs may return failure cases or simply no-op, for which a properly designed application needs to account. Further, the number of dedicated CPUs (cores) are reduced in the constrained mode, whereby the application also needs to ensure that its threading model and processor affinity stand up to thread migration. In one implementation, in the constrained mode, two physical cores are reclaimed, however the number of available threads (e.g., six) need not be reduced. In other implementations such as mobile devices that do not have multicore processors (or a sufficient number of cores to reserve them in an appropriate way), CPU access can be limited. GPU cycles may be limited, and network and hard disk I/O requests may be lowered in priority. Still further, the application should attempt to reduce its resource utilization, often by taking into consideration the fact that being in constrained mode indicates that the user's attention has moved to elsewhere.

Suspending refers to another process lifetime management event that indicates to an application that the application will soon be transitioned to the suspended state 228. The application needs to persist state in preparation for the possibility of thereafter being moved to the terminated state 230. A notification and some reasonable time is given for the application to persist state, because once an application is suspended, the application is frozen, and the application may later be terminated to recover resources, without any opportunity for the application to execute further instructions.

Resuming is an event which indicates to an application that it is returning from the suspended state, which as shown in FIG. 2, may be back to the prior state in which the application was running, either the full state 224 or the constrained state 226 in this example. Resuming may guarantee that the application's memory is in the exact state it was in when the application was suspended. This enables the application to skip the majority of content loading and initialization code. Some resources such as network sessions that cannot be serialized may need to be restored, restarted, or terminated.

It should be noted that in one implementation, an application model has different types of high-level applications, namely exclusive resource applications (ERAs) and shared resource applications (SRAs). In such an implementation, an application's resource model (exclusive resource application or shared resource application) is a static attribute of the application declared by each application as part of its application metadata. Exclusive resource applications have access to a larger amount of system resources (CPU, GPU, memory and so forth) as well as stronger guarantees on the availability of those resources. An effect of exclusive resource application resource guarantees is that in one implementation, only one exclusive resource application can be running as a full mode application at any given time. Shared resource applications have less access to resources, but are capable of running concurrently with other applications. Notwithstanding, full mode and constrained mode concepts apply both to exclusive resource applications and shared resource applications. However, the resources allocated to a full mode exclusive resource application need not be (and typically are not) the same as the resources allocated to a constrained mode exclusive resource application, nor are the resources allocated to a full mode shared resource application typically the same as the resources allocated to a constrained mode shared resource application.

Exclusive resource applications are designed with the ability to run in different active resource states, in which each state has access to different amounts of hardware resources. State transitions are imposed on the application by the system in response to user control. In one example implementation, in the full state, also referred to as the “full screen” state, the application occupies the majority of the screen real estate and has access to the bulk of the hardware resources. This is the state in which the application provides its full experience.

In the constrained state, an exclusive resource application occupies a smaller area of the screen and has access to less CPU and GPU resources relative to the full state. The application is expected to suspend its primary experience and switch to more of an animated pause screen, for example. Transitions between this mode and full-screen are intended to be relatively fast. Note that the constrained mode does not equate to picture-in-picture (PIP), as constrained is an actual mode of an exclusive resource application whereas a PIP is a form of limited shared resource application.

Shared resource applications may be run in the full-screen state in which the application occupies the majority of the screen real estate and has more access to hardware resources, or in the constrained state, in which the application occupies a reduced area of the screen than full-screen. Shared resource applications are notified regarding the state changes in the same way as exclusive resource applications, e.g., via notification mechanisms.

Note that other states, such as “non-visible,” also may exist, e.g., for exclusive resource applications. For example, in a non-visible state, an application may be completely non-visible with respect to screen access, with access to significantly reduced hardware resources. An example purpose of such a state is to allow multiplayer games to maintain their simulation in order to allow seamless transitions back to the constrained or full-screen states. Shared resource applications may not have an exclusive non-visible mode, however certain shared resource applications such as video chat may be allowed to run in a non-visible/background mode for audio and communication functions.

The following table sets forth an example of how resources may be allocated among states and application types in one example embodiment; note that the following symbols are used for certain meanings, namely: (*) Stream may be subdivided; (**) CPUs is only at ˜70% of clock speed; (***) 10% GPU is reserved to allow for certain scenarios; (+) DVD player app is granted access to optical disk drive (ODD); (++) it may be possible to plumb Windows® frameworks for only one plane; and (+++) for certain “wireless display” scenarios, hardware reserve all of the video encoder resources

| | ERA | | SRA | |
|---|---|---|---|---|
| | | Constrained | Full-screen | |
| | Full-screen | Pause mode | Instant switch | Constrained |
| Example | Full game | (game sim | to full-screen | Apps that run |
| scenario | experience | stays active) | app | Constrained |
| Memory | 5 GB | 5 GB | 512 MB | 512 MB |
| CPU | 6 cores | 4 cores | 2 cores | 2 cores |
| GPU | 90% | 45% | 40% | 40% |
| Audio | 100% | 100% | 100% | Software only |
| XMA and | | | | |
| Sub- | | | | |
| system | | | | |
| Audio | System | System | System | System |
| MEC, | brokered | brokered | brokered | brokered |
| Codec, | | | | |
| FFX | | | | |
| Engines | 4 engines | 4 engines | — | — |
| | (including | (including | | |
| | JPEG and | JPEG and | | |
| | LZ77) | LZ77) | | |
| Video | 1080p@30 (*) | 1080p@30 (*) | 1080p@30 (*) | 480p@60 or |
| Decoder | | | | 720p@30 |
| Video | 720p@30 (*) | 720p@30 (*) | 720p@30 (*) | 480p@60 or |
| Encoder | | | | 720p@30 |
| (++)(+++) | | | | |
| Scaler/ | 2 planes | 2 planes | 2 planes (++) | — |
| Compositor | | | | |
| Display | Control 3D or | Control 3D or | Control 3D or | — |
| Mode | not, 24 Hz or | not, 24 Hz or | not | |
| | not | not | | |
| ESRAM | 100% | 100% | 100% | — |
| Flash | — | — | — | — |
| ODD | (+) | (+) | — | — |
| Utilization | | | | |
| HDD | 80% | 80% | 40% | 10% |
| Utilization | | | | |
| Network | System | System | System | System |
| | brokered | brokered | brokered | brokered |

In some embodiments, with respect to GPU usage, when an exclusive resource application is constrained, a constrained shared resource application that is running concurrently has access to approximately forty-five percent of the GPU. This allows for full-size 1080p rendering with significant complexity. DrawPrim-granularity GPU preemption may be used and based off a timer, whereby the reservation is not tied to the game's frame-rate. The constrained shared resource application is guaranteed constant, consistent performance. Constrained shared resource applications are able to have background rendering that can extend over multiple frames while still updating the screen at sixty Hz.

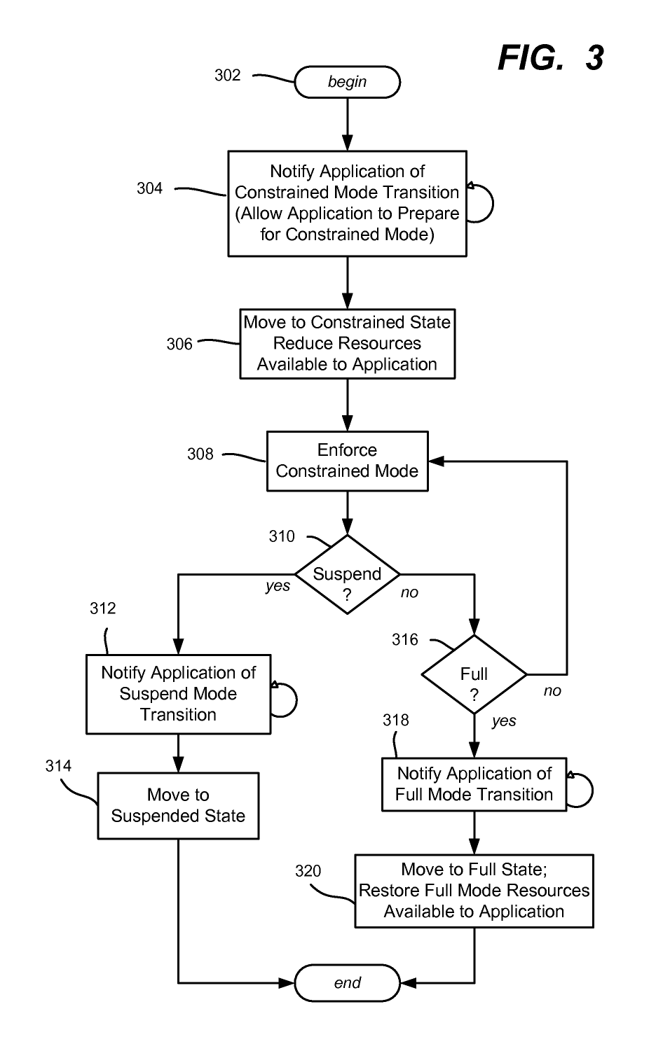

FIG. 3 is a flow diagram showing example steps that may be taken when transitioning an application's modes/states, starting (step 302) from the perspective of an application running in full mode that is being transitioned to constrained mode. At step 304, (as with any state transition), the application is notified by a message when the system is putting the application in the different state, in this example the constrained state, with a small amount of grace period (represented by the looping arrow).

Step 306 moves the application to the constrained state, where its resources are limited in some way. Note that for robustness, the system ensures to the extent possible that an application does not actually have to change its behavior when the application receives a state-change notification (although the application developer is encouraged to write the application to change its behavior). However, the system does to an extent enforce the constrained mode (step 308) with respect to resource access, e.g., by reducing cores and GPU access, by denying requests for more memory than allowed, by masking the screen so that the constrained mode application cannot draw outside of a certain area, and so forth.

As previously shown in FIG. 2, when in the constrained state, the application may be transitioned to the suspended state (determined via step 310) or the full state (determined via step 316). If not transitioning, the application remains running in the constrained mode at step 308; note that step 316 is shown as looping back to step 308, however in actuality the transitions may be event driven.

If instead step 310 determines that the application is to be suspended, step 312 notifies the application, providing the application with time to preserve its state as mentioned above. Step 314 represents moving the application to the suspended state, where it may be terminated, or resumed to its previous running state, which in this example was constrained. Note however that it is feasible to have a constrained mode application suspended, and resumed to the full state.

Returning to step 316, if a constrained application is to be moved back to the full state, step 318 provides the notification, along with an appropriate amount of time for the application to prepare for the transition. Step 320 represents moving the application to the full state, restoring the full amount of resources.

As can be seen, applications running in the full mode are typically the active target of user interaction and draw to (substantially) the full screen. Full mode applications have access to a dedicated amount of resources (typically the largest amount of memory and CPU time). Resource allocation is guaranteed in the case of an exclusive resource application. Applications running in the constrained mode may only draw to a reduced screen area. Constrained mode applications have less resource allocation than what they have the full state.

### Example Operating Environment

It can be readily appreciated that the above-described implementation and its alternatives may be implemented on any suitable computing device, including a gaming system, personal computer, tablet, DVR, set-top box, smartphone and/or the like. Combinations of such devices are also feasible when multiple such devices are linked together. For purposes of description, a gaming (including media) system is described as one exemplary operating environment hereinafter.

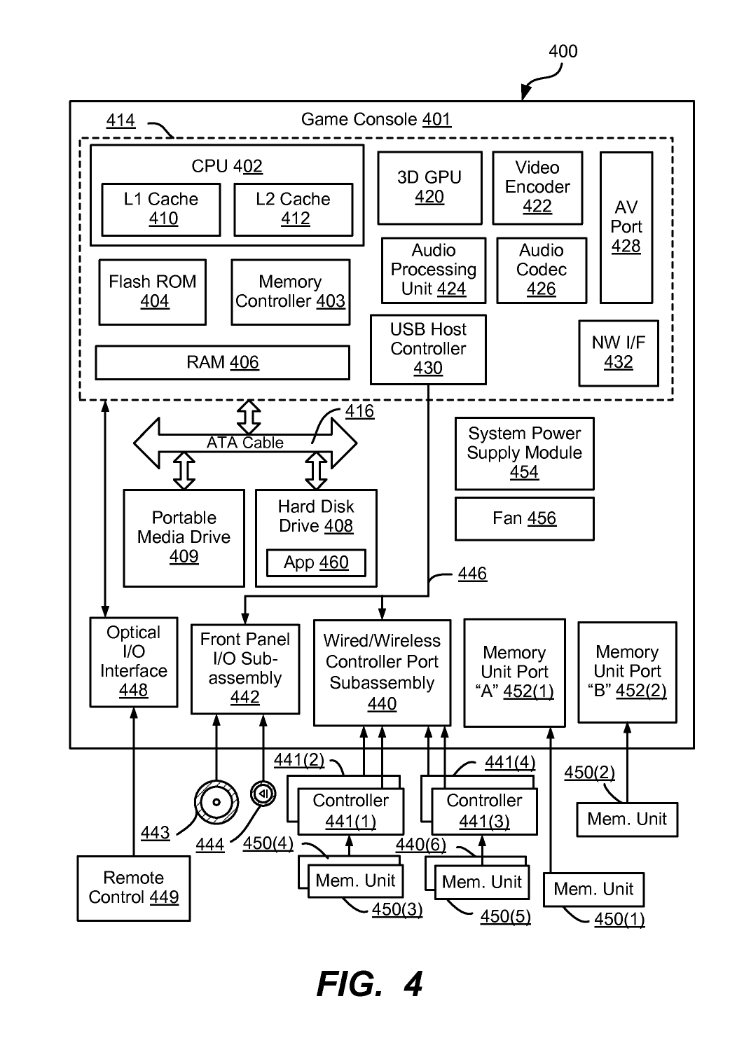

FIG. 4 is a functional block diagram of an example gaming and media system 400 and shows functional components in more detail. Console 401 has a central processing unit (CPU) 402, and a memory controller 403 that facilitates processor access to various types of memory, including a flash Read Only Memory (ROM) 404, a Random Access Memory (RAM) 406, a hard disk drive 408, and portable media drive 409. In one implementation, the CPU 402 includes a level 1 cache 410, and a level 2 cache 412 to temporarily store data and hence reduce the number of memory access cycles made to the hard drive, thereby improving processing speed and throughput.

The CPU 402, the memory controller 403, and various memory devices are interconnected via one or more buses (not shown). The details of the bus that is used in this implementation are not particularly relevant to understanding the subject matter of interest being discussed herein. However, it will be understood that such a bus may include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, the CPU 402, the memory controller 403, the ROM 404, and the RAM 406 are integrated onto a common module 414. In this implementation, the ROM 404 is configured as a flash ROM that is connected to the memory controller 403 via a Peripheral Component Interconnect (PCI) bus or the like and a ROM bus or the like (neither of which are shown). The RAM 406 may be configured as multiple Double Data Rate Synchronous Dynamic RAM (DDR SDRAM) modules that are independently controlled by the memory controller 403 via separate buses (not shown). The hard disk drive 408 and the portable media drive 409 are shown connected to the memory controller 403 via the PCI bus and an AT Attachment (ATA) bus 416. However, in other implementations, dedicated data bus structures of different types can also be applied in the alternative.

A three-dimensional graphics processing unit 420 and a video encoder 422 form a video processing pipeline for high speed and high resolution (e.g., High Definition) graphics processing. Data are carried from the graphics processing unit 420 to the video encoder 422 via a digital video bus (not shown). An audio processing unit 424 and an audio codec (coder/decoder) 426 form a corresponding audio processing pipeline for multi-channel audio processing of various digital audio formats. Audio data are carried between the audio processing unit 424 and the audio codec 426 via a communication link (not shown). The video and audio processing pipelines output data to an A/V (audio/video) port 428 for transmission to a television or other display/speakers. In the illustrated implementation, the video and audio processing components 420, 422, 424, 426 and 428 are mounted on the module 414.

FIG. 4 shows the module 414 including a USB host controller 430 and a network interface (NW I/F) 432, which may include wired and/or wireless components. The USB host controller 430 is shown in communication with the CPU 402 and the memory controller 403 via a bus (e.g., PCI bus) and serves as host for peripheral controllers 434. The network interface 432 provides access to a network (e.g., Internet, home network, etc.) and may be any of a wide variety of various wire or wireless interface components including an Ethernet card or interface module, a modem, a Bluetooth module, a cable modem, and the like.

In the example implementation depicted in FIG. 4, the console 401 includes a controller support subassembly 440, for supporting four game controllers 441(1)-441(4). The controller support subassembly 440 includes any hardware and software components needed to support wired and/or wireless operation with an external control device, such as for example, a media and game controller. A front panel I/O subassembly 442 supports the multiple functionalities of a power button 443, an eject button 444, as well as any other buttons and any LEDs (light emitting diodes) or other indicators exposed on the outer surface of the console 401. The subassemblies 440 and 442 are in communication with the module 414 via one or more cable assemblies 446 or the like. In other implementations, the console 401 can include additional controller subassemblies. The illustrated implementation also shows an optical I/O interface 448 that is configured to send and receive signals (e.g., from a remote control 449) that can be communicated to the module 414.

Memory units (MUs) 450(1) and 450(2) are illustrated as being connectable to MU ports “A” 452(1) and “B” 452(2), respectively. Each MU 450 offers additional storage on which games, game parameters, and other data may be stored. In some implementations, the other data can include one or more of a digital game component, an executable gaming application, an instruction set for expanding a gaming application, and a media file. When inserted into the console 401, each MU 450 can be accessed by the memory controller 403.

A system power supply module 454 provides power to the components of the gaming system 400. A fan 456 cools the circuitry within the console 401.

An application 460 comprising machine instructions is typically stored on the hard disk drive 408. When the console 401 is powered on, various portions of the application 460 are loaded into the RAM 406, and/or the caches 410 and 412, for execution on the CPU 402. In general, the application 460 can include one or more program modules for performing various display functions, such as controlling dialog screens for presentation on a display (e.g., high definition monitor), controlling transactions based on user inputs and controlling data transmission and reception between the console 401 and externally connected devices.

The gaming system 400 may be operated as a standalone system by connecting the system to high definition monitor, a television, a video projector, or other display device. In this standalone mode, the gaming system 400 enables one or more players to play games, or enjoy digital media, e.g., by watching movies, or listening to music. However, with the integration of broadband connectivity made available through the network interface 432, gaming system 400 may further be operated as a participating component in a larger network gaming community or system.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor, comprising, moving an application from a full running state into a constrained running state, including reducing a set of resources available to the application.

2. The method of claim 1 wherein moving the application from the full running state into a constrained running state includes notifying the application of an upcoming transition to the constrained running state.

3. The method of claim 1 further comprising delaying before moving the application from the full running state into the constrained running state to allow the application to prepare for the constrained running state.

4. The method of claim 1 further comprising, returning the application from the constrained running state back to the full running state.

5. The method of claim 1 wherein moving the application from the full running state into a constrained running state occurs in response to detecting user interaction.

6. The method of claim 1 wherein moving the application from the full running state into a constrained running state occurs in response to launching another application into a full running state.

7. The method of claim 1 further comprising, running another application in the full running state while the application is in the constrained running state.

8. The method of claim 1 further comprising, moving the application from the constrained running state into a suspended state.

9. The method of claim 8 further comprising, resuming the application from the suspended state to the constrained running state.

10. The method of claim 8 further comprising, resuming the application from the suspended state to the full running state.

11. The method of claim 1 wherein reducing the set of resources available comprises reducing one or more CPU cores reserved for the application, reducing memory accessible to the application, or limiting GPU access, or any combination of reducing one or more CPU cores reserved for the application, reducing memory accessible to the application, or limiting GPU access.

12. The method of claim 1 wherein reducing the set of resources available comprises reducing screen access.

13. In a computing environment, a system comprising, a shell component configured to run applications in different modes, including to run an application in a constrained running mode, in which the constrained running mode has reduced resources available to the application relative to resources available to applications in a full running mode, the application in the constrained running mode configured to run in parallel with another application that is run in a full running mode.

14. The system of claim 13 wherein the application comprises an exclusive resource application.

15. The system of claim 13 wherein the application comprises a shared resource application.

16. The system of claim 13 wherein the reduced resources available to the application in the constrained mode comprises at least one of: a reduced number of CPU cores reserved to the application, reduced memory accessible to the application, or limited GPU access capability of the application.

17. The system of claim 13 wherein one of the reduced resources available to the application in the constrained mode corresponds to reduced screen access.

18. The system of claim 13 wherein the shell component operates on a game console or a mobile device.

19. One or more computer-readable media having computer-executable instructions, which when executed perform steps, comprising, moving a running application from a full running state into a constrained running state, including notifying the application of a state transition, and reducing one or more resources available to the constrained application including reducing at least one of: a number of CPU cores reserved to the application, an amount of memory accessible to the application, GPU access of the application, or screen area accessible to the application.

20. The one or more computer-readable media of claim 19 having further computer-executable instructions comprising, running another application in the full mode while the application is running in parallel in the constrained mode.
